(19) United States
(12) Patent Application Publication
(10) Pub. No.: US 2014/0363011 A1
(43) Pub. Date: Dec. 11, 2014

(54) ELIMINATION SYSTEM FOR DIVERTING DENTAL INSTRUMENT NOISE

(71) Applicant: YI SHENG CO., LTD., Taoyuan County (TW)

(72) Inventors: Jen-Fang YU, Taoyuan County (TW); Kun-Che LEE, Taoyuan County (TW)

(73) Assignee: YI SHENG CO., LTD., Taoyuan County (TW)

(21) Appl. No.: 14/291,423

(22) Filed: May 30, 2014

(30) Foreign Application Priority Data
Jun. 5, 2013 (TW) 102119959

(51) Int. Cl. G10K 11/175; A61C 1/08

(52) U.S. Cl. CPC G10K 11/175; A61C 1/08
USPC 381/73.1

(57) ABSTRACT

An elimination system for diverting dental instrument noise includes an audio player, a sound sensor, and a controller. The audio player is used for broadcasting an audio content. The sound sensor may sense noise from a dental instrument, thereby outputting a sensing signal. The controller is electrically connected with the audio player and the sound sensor. According to the sensing signal from the sound sensor, the controller controls the audio content that is broadcasted by the audio player.

### FIELD OF THE INVENTION

The present invention relates to an elimination system, and more particularly to an elimination system for diverting dental instrument noise.

### BACKGROUND OF THE INVENTION

Dental disease is annoying to everyone. When the patient is in a dental examination room, the patient is usually afraid of the noise from the dental instruments. Due to the dental instrument noise, the will of the patient to see the doctor is usually reduced.

### SUMMARY OF THE INVENTION

The present invention provides an elimination system for diverting dental instrument noise. According to the noise features of various dental instruments, the elimination system broadcasts a corresponding audio source in order to divert the patient's attention. Consequently, the patient's psychological fear about the dental equipment noise is largely reduced.

In accordance with an aspect of the present invention, there is provided an elimination system for diverting dental instrument noise. The elimination system includes an audio player, a sound sensor, and a controller. The audio player is used for broadcasting an audio content. The sound sensor may sense noise from a dental instrument, thereby outputting a sensing signal. The controller is electrically connected with the audio player and the sound sensor. According to the sensing signal from the sound sensor, the controller controls the audio content that is broadcasted by the audio player.

In an embodiment, the controller includes an audio source storage unit, a decibel value storage unit, and a processing unit. The audio source storage unit stores plural default audio sources. The decibel value storage unit stores plural decibel value ranges. The processing unit is electrically connected with the audio source storage unit and the decibel value storage unit for reading the plural default audio sources and the plural default decibel value ranges. After the sensing signal from the sound sensor is compared with the default decibel value ranges, the processing unit selects one of the default audio sources to be broadcasted by the audio player.

In an embodiment, the elimination system further includes a power supply. The power supply is electrically connected with the audio player, the sound sensor and the controller.

In an embodiment, the power supply is charged by a wired charging technology or a wireless charging technology.

In an embodiment, the wireless charging technology is implemented by a solar energy charger or an electromagnetic induction charger.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of an elimination system for diverting dental instrument noise according to an embodiment of the present invention.

### DETAILED DESCRIPTION OF THE PREFERRED EMBODIMENT

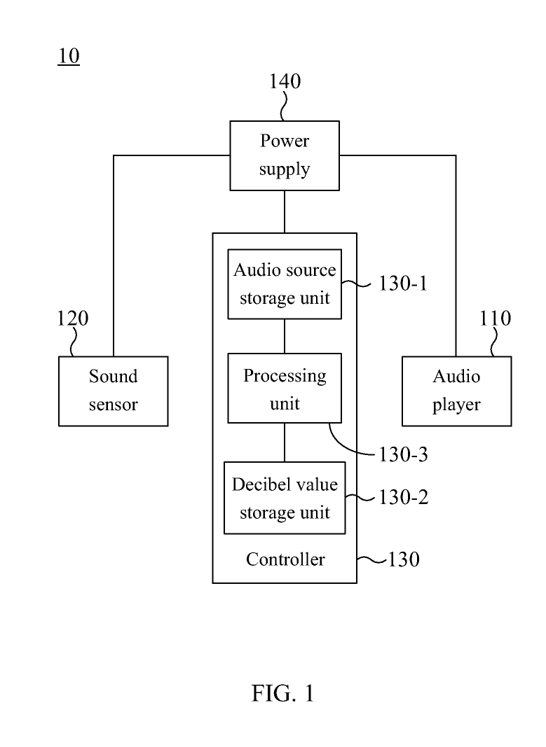

FIG. 1 schematically illustrates the architecture of an elimination system for diverting dental instrument noise according to an embodiment of the present invention. As shown in FIG. 1, the elimination system 10 comprises an audio player 110, a sound sensor 120, and a controller 130. The sound sensor 120 is used for sensing the dental instrument noise, thereby outputting a sensing signal. The controller 130 is electrically connected with the audio player 110 and the sound sensor 120. According to the sensing signal from the sound sensor 120, the controller 130 may control the audio content that is broadcasted by the audio player 110. Consequently, the audio content to be heard by the patient is adjusted.

In an embodiment, the controller 130 comprises an audio source storage unit 130-1, a decibel value storage unit 130-2, and a processing unit 130-3. Moreover, plural default audio sources are previously stored in the audio source storage unit 130-1. These default audio sources may be classified into four types according to the effects of inhibiting at least four audio quality parameters of the noise. For example, the at least four audio quality parameters comprise loudness, sharpness, roughness and fluctuation strength. After the dental instrument noise sensed by the sound sensor 120 is analyzed by the controller 130, the controller 130 may judge whether the dental instrument noise complies with one of the four audio quality parameters. After the type of the dental instrument noise is realized by the controller 130, the audio content to be broadcasted by the audio player 110 is correspondingly controlled. Moreover, plural default decibel value ranges are stored in the decibel value storage unit 130-2. The processing unit 130-3 is electrically connected with the audio source storage unit 130-1 and the decibel value storage unit 130-2. The processing unit 130-3 may read the default audio sources and the default decibel value ranges. After the sensing signal from the sound sensor 120 is compared with the default decibel value ranges by the processing unit 130-3, the processing unit 130-3 selects one of the default audio sources to be broadcasted by the audio player 110.

In the above embodiment, the audio source storage unit 130-1 and the decibel value storage unit 130-2 of the controller 130 are used for storing the default audio sources and the default decibel value ranges, respectively. However, those skilled in the art will readily observe that numerous modifications and alterations may be made while retaining the teachings of the invention. For example, in case that the processing unit 130-3 of the controller 130 has sufficient storage space, the default audio sources and the default decibel value ranges may be stored in the storage space of the processing unit 130-3. Under this circumstance, the audio source storage unit 130-1 and the decibel value storage unit 130-2 may be omitted. The configurations of the controller 130 are presented herein for purpose of illustration and description only. It is noted that the controller 130 may have various hardware forms according to the practical requirements.

In some embodiments, the elimination system 10 further comprises a power supply 140 for providing systematic power. The power supply 140 is electrically connected with the audio player 110, the sound sensor 120 and the controller 130. The power supply 140 may be charged by a wired charging technology or a wireless charging technology. For example, the wireless charging technology is implemented by a solar energy charger or an electromagnetic induction charger.

From the above descriptions, the present invention provides an elimination system for diverting dental instrument noise. The elimination system comprises an audio player, a sound sensor, and a controller. According to the noise features of various dental instruments, the elimination system broadcasts a corresponding audio source in order to divert the patient's attention. Consequently, the patient's psychological fear about the dental equipment noise is largely reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An elimination system for diverting dental instrument noise, the elimination system comprising:
an audio player for broadcasting an audio content;
a sound sensor for sensing noise from a dental instrument, thereby outputting a sensing signal; and
a controller electrically connected with the audio player and the sound sensor, wherein according to the sensing signal from the sound sensor, the controller controls the audio content that is broadcasted by the audio player.

2. The elimination system according to claim 1, wherein the controller comprises:
an audio source storage unit for storing plural default audio sources;
a decibel value storage unit for storing plural decibel value ranges; and
a processing unit electrically connected with the audio source storage unit and the decibel value storage unit for reading the plural default audio sources and the plural default decibel value ranges, wherein after the sensing signal from the sound sensor is compared with the default decibel value ranges, the processing unit selects one of the default audio sources to be broadcasted by the audio player.

3. The elimination system according to claim 1, further comprising a power supply, wherein the power supply is electrically connected with the audio player, the sound sensor and the controller.

4. The elimination system according to claim 3, wherein the power supply is charged by a wired charging technology or a wireless charging technology.

5. The elimination system according to claim 4, wherein the wireless charging technology is implemented by a solar energy charger or an electromagnetic induction charger.
